(19) United States
(12) Patent Application Publication
(10) Pub. No.: US 2010/0257092 A1
(43) Pub. Date: Oct. 7, 2010

(54) SYSTEM AND METHOD FOR PREDICTING A MEASURE OF ANOMALOUSNESS AND SIMILARITY OF RECORDS IN RELATION TO A SET OF REFERENCE RECORDS

(76) Inventor: Ori Einhorn, Efrat (IL)

Correspondence Address: The Law Office of Michael E. Kondoudis, 888 16th Street, N.W., Suite 800, Washington, DC, 20006, US

(21) Appl. No.: 12/664,417

(22) PCT Filed: Jun. 17, 2008
(86) PCT No.: PCT/IL08/00825

§ 371 Date: Dec. 14, 2009

Related U.S. Application Data
(60) Provisional application No. 60/929,225, filed on Jun. 18, 2007.

(51) Int. Cl. G06Q 40/00; G06F 17/30

(52) U.S. Cl. 705/38; 707/607; 707/E17.005; 707/703; 705/44

(57) ABSTRACT

The present invention presents system and method for predicting a measure of anomalousness and similarity of input records in relation to a set of reference records, both input records and reference records comprising set of parameters.

### FIELD OF THE INVENTION

The present invention generally relates to system and method for predicting measure of anomalousness and similarity of records in relation to a set of reference records. More specifically, the present invention relates to system and method for predicting the measure of anomalousness and similarity of records in relation to a set of reference records by identifying anomalous and similar sequences.

### BACKGROUND OF THE INVENTION

Huge quantities of data are gathered and stored in the modern world. There is a need to scan these data in real time and detect anomalous data. For example, financial collect and store vast amount of data describing financial transactions. Each financial transaction is characterized by a set of parameters such as: timestamp (date and time of the transaction), transaction owner, account, the vendor (store. ATM, POS and others), the place of the transaction and a monetary value. Anomalous data may indicate for example fraud or identity theft, and there is an obvious need to detect these as soon as possible, preferably in real time. Anomalous data may also indicate new business opportunities, for example to offer a customer a product or service, in real time, based on the historical sequences of that customer, including the last transaction. Many solutions are known in the art that identify anomalous data based on pre-defined rules, especially user-defined rules, however rules are static and non comprehensive, therefore important anomalous data may slip through and be left undetected. Fraudsters, for example, may adopt their delinquent behavior in view of the rules in the system they are trying to defeat. There are also disadvantages of calculation speed and storage space. Setting up a single rule is easy for an engineer skilled in the art. Setting up about 10 rules and maintaining them raises some engineering minor difficulties, but above about a few tens of rules it is difficult to construct a system that can run in real time. A system employing over 100 rules will not run even in “near real time”, and maintaining these rules becomes a very difficult process. The disk space used for storing more that about 100 rules typically takes more disk space than the actual raw data. Many solutions are known in the art that comprise learning systems, for example employing neural networks, however those solutions are slow to adopt and non comprehensive.

The disadvantages of those methods can be summarized as follows:
The modeling process is off-line and takes a long time (sometimes several weeks).
The less one trains the net the less accurate the model is.
Today most companies using a learning process run this learning process not more often than once in a quarter of a year, so the knowledge supplied to the learning process is limited, old and sometimes inaccurate.
Deep historical knowledge requires massive aggregation of data and profiling, and duplication of transaction data for sequence training.
Achieving good accuracy requires formulating a large number of sub categories, therefore:
   A large number of “sub-models” are required due to the differences in categories
   A large number of categories can not be processed in real time
   Processing can't be done per customer or per nearest neighbor, but only by sub-categories.
Each single system supports one solution due to different accumulators, sub-categories, and sub-models.
The “Black Box” approach of this type of solution does not allow for reasoning. An alert is typically issued without an explanation.
This type of solution is relatively expensive to implement.

There remains a need to identify anomalous data in large data sets without resorting to pre-defined rules, but only according to posteriori analysis to the data as it is gathered.

U.S. Pat. No. 6,965,886, for example, discloses a system and a method for analyzing and utilizing data by executing complex analytical models in real time. Specifically, it describes a multi dimensional data structure that enables solving user-defined, integrated analytical rules, and the drawbacks of user-defined rules have been explained herein below.

US application number 20060149674 discloses a system and a method for identity-based fraud detection for transactions using a plurality of historical identity records.

U.S. Pat. No. 6,714,918 discloses a system and a method for detecting fraudulent transactions

U.S. Pat. No. 7,185,805 discloses a wireless check authorization.

WO application number 2004003676 and AU application number 2003240200 describe Fraud Detection.

US application number 2004148256 describes fraud detection within an electronic payment system

US application number 2005182712 describes incremental compliance environment, an enterprise-wide system for detecting fraud.

US application number 2004064401 discloses systems and methods for detecting fraudulent information.

The prior art deals with individual data items, transactions or events. Even when not relying on predefined rules, prior arts attempt to compare each item with similar item known in the data base. This can be only partially successful, since some anomalous items are normal if examined out of context, and can only be detected when viewed in a larger context. For example, a stolen credit card can be used to purchase some merchandize at time and location typical of its normal use, but only observing a chain of purchases may reveal its true nature, for example when it is not similar to any chain of events known in the history of the use of the same card.

There exists a long felt need for a system and method for identifying anomalous records in relation to a set of reference records, especially a large set of many records, and especially in real time, without resorting to any pre-defined rules, and without employing a learning system, but employing posteriori statistical analyses and taking into account a sequence of events rather the a singular event.

### SUMMARY OF THE INVENTION

It is thus one embodiment of the present invention to provide a system and a method for predicting a measure of anomalousness and similarity of records in relation to a set of reference records

It is an object of the present invention to provide a system for predicting a measure of anomalousness and similarity of input records in relation to a set of reference records, both the input records and the reference records comprises set of parameters, wherein the system comprises an online subsystem and an offline subsystem. The offline subsystem comprises a data storage operative to store the set of reference records, a projection analyzer connected to the data storage and operative to identify the set of parameters, a projected data storage, wherein the projection analyzer is operative to project parameters in a multi-dimensional space and store the results in the projected data storage. The online system comprises a data receiver operative to receive a candidate input record, a data cache connected to the receiver and operative to cache the candidate record, a comparator connected to both the receiver and the data cache, and operative to define a candidate sequence of records that comprises the candidate record and zero or more records stored in the cache, a calculator connected to both the comparator and the data storage, and operative to identify sequences of reference records similar to the candidate sequence of records, and to assign a measure of anomalousness to the candidate record; and, an output device connected to the calculator and operative to mark the candidate record as anomalous.

It is in the scope of the present invention to provide a system as described above, wherein the projection analyzer is further operative to quantify the set of parameters.

It is further in the scope of the present invention to provide a system as described above, wherein the calculator is operative to calculate any of the following numbers: the number of chosen records, the number or weighted sum of chosen marked records, or the percentage of chosen marked records, where the chosen records are records of at least one neighboring sequence to the candidate sequence of records.

It is further in the scope of the present invention to provide a system as described above, wherein the calculator is operative to calculate a difference between parameters of at least two records of at least one neighboring sequence to the candidate sequence of records.

It is further in the scope of the present invention to provide a system as described above, wherein the difference represents a time difference.

It is further in the scope of the present invention to provide a system as described above, wherein the calculator is operative to identify at least one field common to the candidate sequence of records, and wherein the output device is operative to output the field.

It is further in the scope of the present invention to provide a system as described above, wherein the calculator is operative to identify a corresponding field in the reference records that is corresponding to the one common field, and wherein the output device is operative to output the corresponding field.

It is further in the scope of the present invention to provide a system as described above, wherein both the calculator and the projection analyzer are operative to project parameters in a multi-dimensional space and store the results in the projected data storage.

It is another object of the present invention to provide a method for predicting a measure of anomalousness and similarity of input records in relation to a set of reference records, both the input records and the reference records comprising a set of parameters, and the method comprising a preparation step followed by an operation step. The preparation step comprises the steps of receiving the set of reference records, identifying the set of parameters. The operation step comprises the steps of receiving a candidate record, caching the candidate record, selecting cached records similar to the candidate record, forming a sequence of records comprises the candidate record, and zero or more selected cached records, identifying similar sequences of reference records, calculating a measure of anomalousness relating to the candidate record, and predicting a measure of anomalousness for the candidate record.

It is in the scope of the present invention to provide a method as described above, wherein the step of preparation further comprises quantifying at least one parameter of the set of parameters of the reference records.

It is further in the scope of the present invention to provide a method as described above, wherein the step of preparation further comprises transforming at least one parameter of the set of parameters of the reference records to obtain a normalized set of parameters.

It is further in the scope of the present invention to provide a method as described above, wherein the step of predicting comprises the steps of generating a suspect record by marking a candidate record as suspect, and marking the suspect record as anomalous.

It is further in the scope of the present invention to provide a method as described above, wherein the step of predicting comprises adding the candidate record to the set of reference records.

It is further in the scope of the present invention to provide a method as described above, wherein the step of calculating comprises calculating any of the following numbers: the number of chosen records, the number of chosen marked records, or the percentage of chosen marked records, where the chosen records are records of at least one neighboring sequence to the candidate sequence of records.

It is further in the scope of the present invention to provide a method as described above, also comprising the steps of identifying at least one field common to the candidate sequence of records, and identifying a corresponding field in the reference records corresponding to the one common field.

It is further in the scope of the present invention to provide a method as described above, also comprises the steps of reporting a prediction that differing parameters of the one field and of the corresponding field represent one entity.

It is further in the scope of the present invention to provide a method as described above, wherein the step of identifying the set of parameters comprises the step of projecting records into multi-dimensional space.

It is finally in the scope of the present invention to provide a method as described above, wherein the step of projecting comprises aggregating a set of discrete parameters, deciding on a group of dimensions into which to project the set of discrete parameters, and projecting records into a multi-dimensional space comprises the group of dimensions.

### BRIEF DESCRIPTION OF THE INVENTION

In order to understand the invention and to see how it may be implemented in practice, a preferred embodiment will now be described, by way of non-limiting example only, with reference to the accompanying drawing, in which

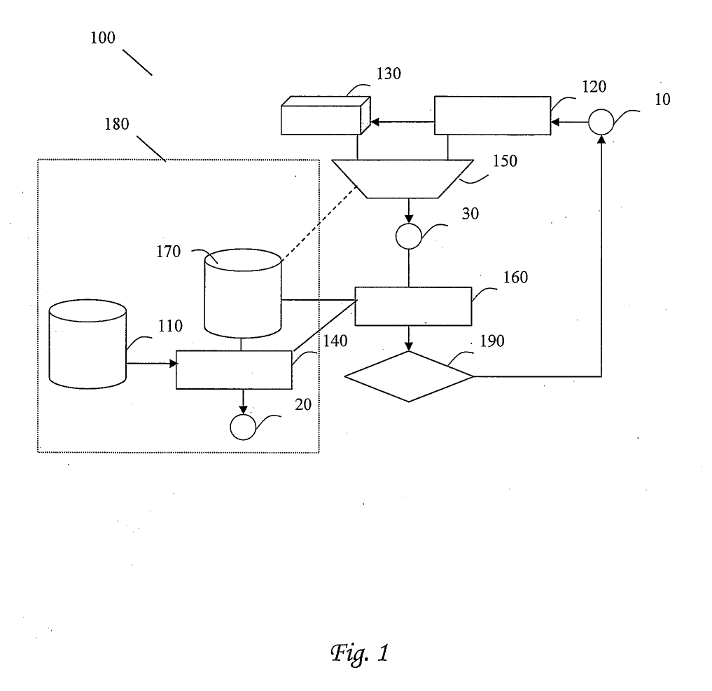

FIG. 1 schematically presents a system according to the present invention;

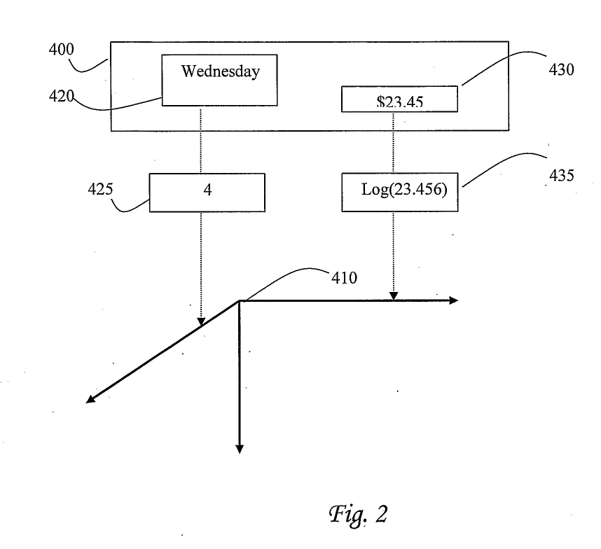

FIG. 2 schematically presents a projection of record parameters to a multidimensional space;

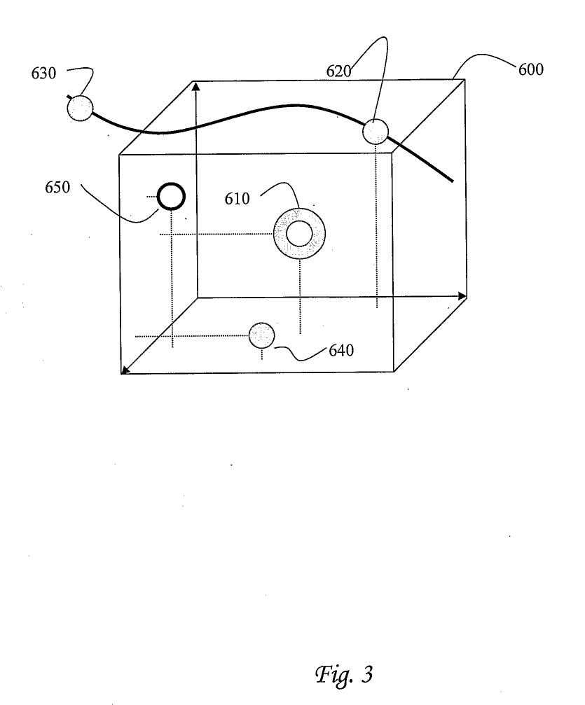

FIG. 3 schematically presents records in a multidimensional space;

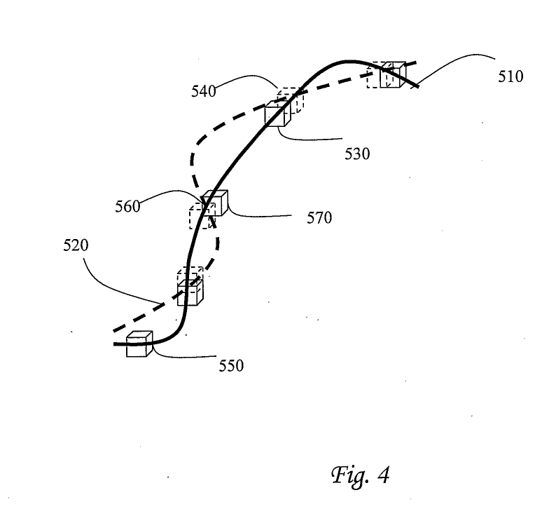

FIG. 4 schematically presents neighboring sequences of records;

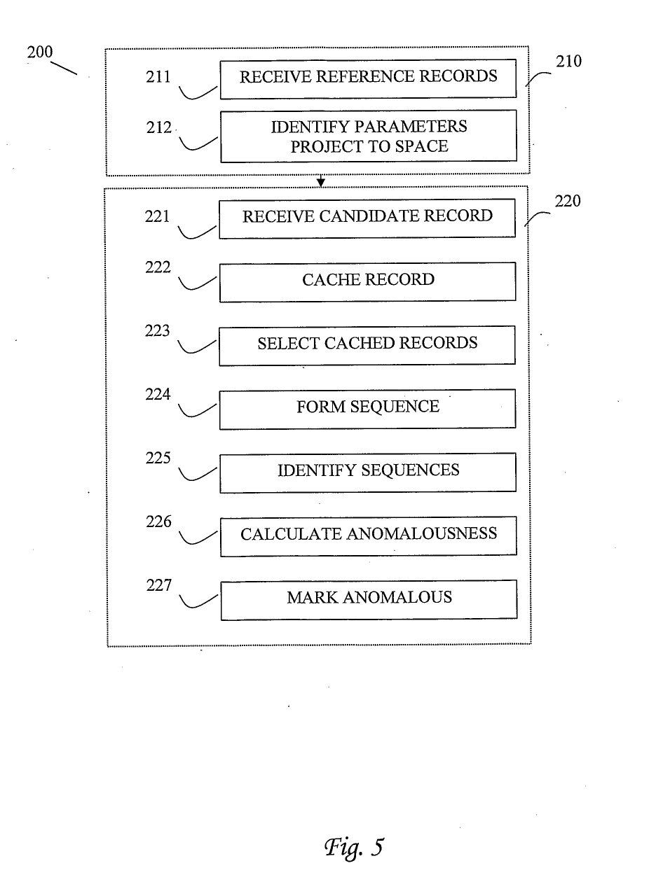

FIG. 5 schematically presents a method according to the present invention;

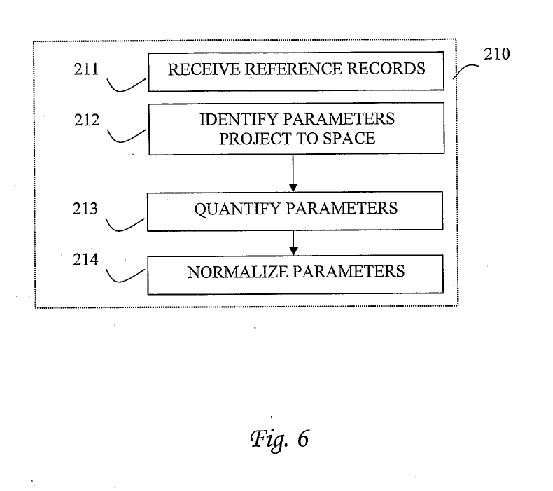

FIG. 6 schematically presents a detail of presents a method according to the present invention;

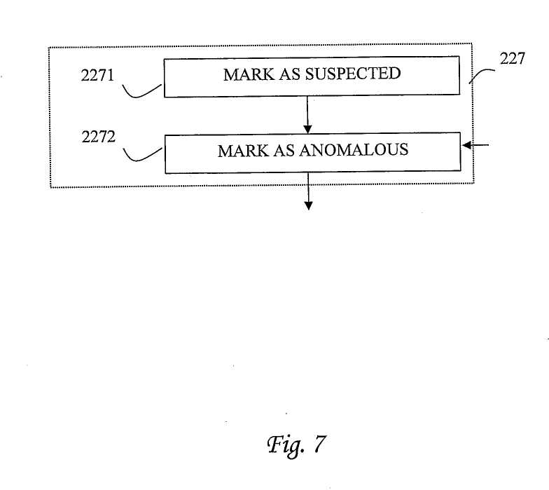

FIG. 7 schematically presents two steps in the prediction of the amount of anomalousness; and

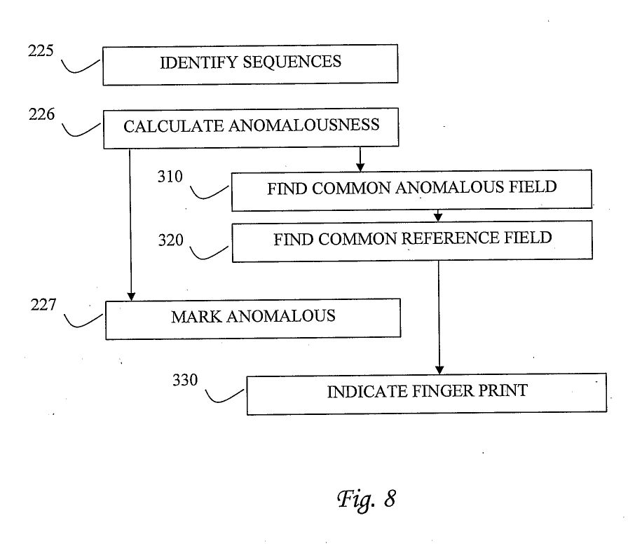

FIG. 8 schematically presents a method for finger printing according to the present invention.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a system and a method for identifying anomalous records in relation to a set of reference records

The term ‘field’ refers in the present invention to an atomic unit of information, such as a customer name, an account number, date, time of an event, amount of money, geographic location, type of merchandize, etc. It is atomic in the sense that it would loose its meaning if broken to parts. For example the time “12:34” would loose its meaning of time indication of broken into individual characters or digits.

The term ‘parameter’ refers in the present invention to any numerical quantity calculated from a field. For example, given a field describing a geographic location, it is possible to define the distance in miles between the location and the North Pole as a parameter.

The term ‘record’ refers in the present invention to any set of fields that describes one item or datum in a data set. For example one transaction is represented by one record in a data set of transactions, and it may comprise fields such as date, account number etc.

A parameter of a record is a parameter derived from any of the fields in the record.

The term ‘candidate record’ refers in the present invention to a record for which there is a need to determine whether it is anomalous or not.

The term ‘reference record’ refers in the present invention to a record against which candidate records are compared, and for a factual basis for determining which are anomalous and which are not. For example if, all reference records are identical, and if a candidate record is also identical to any of them, then the candidate can be predicted to have a low measure of anomalousness.

The term ‘marked reference record’ refers in the present invention to a reference record indicated as an anomalous record.

The term ‘sequence’ refers in the present invention to a set of records describing actions performed in a specific order and within a specific time window.

The term ‘marked reference sequence’ refers in the present invention to a sequence of reference records, in which most or all records in the sequence are marked reference records.

The term ‘multidimensional space’ refers in the present invention to mathematical space defined by a set of dimensions, where each dimension represents a parameter or any combination of parameters. At least one ‘measure of distance’ can always be defined in such a multidimensional space.

The term ‘cohabiting sequences’ refers in the present invention to two sequences sharing a multidimensional spaces defined by parameters of records in both sequences. Thus cohabiting sequences are said to cohabit in this space.

The term ‘corresponding sequences’ refers in the present invention to cohabiting sequences, where there exists a 1:1 mapping between a significant number of records in one of the sequences and the same number of corresponding records in the other.

The term ‘neighboring sequences’ refers in the present invention to corresponding sequences wherein there exists a measure of distance in a multidimensional space in which the corresponding sequences cohabit, and the distance between each record and its corresponding record, according to this measure of distance is considered small . . . .

The term ‘anomalousness’ describing a given sequences of records refers in the present invention to any attribute of the sequence calculated from a set of its neighboring reference sequences, while distinguishing between those that are marked and those that are not.

The term ‘similarity’ describing sequences of records refers in the present invention to a special case of anomalousness, in which the attribute of the given sequence is calculated, inter alia, from at least one record in at least one of its neighboring reference sequence, for which record there exists no corresponding record in the given sequence.

The term ‘fingerprint’ refers in the present invention to a distribution or collection of sequences or records which defines uniquely a certain value of a field common to these records. This field often describes a person.

The present invention is useful for detecting or predicting anomalousness of data. Such data can either carry negative meaning to the user of the invention, for example in the case of the detection or prediction of fraud, or carry a positive meaning for the user, such as in the identification of business opportunities. The present invention is also useful for fingerprinting. Further more, the present invention is useful for predicting the next step, using the similarity concept. This can be used in order to predict the next step of the fraudster or in order to submit the optimal voucher to a specific customer.

A key insight leading to the present invention is that in order to fully understand a process one must not view each transaction as a single act, but as a link in a chain, and view the sequence of the events as a complete process. Allegorizing each transaction to a word and the full sequence to a sentence, one can determine that in order to fully understand what is being said one can not relay on a single word, but must hear the full sentence. A positive word (like “good”) can turn into something with a negative meaning in some cases (such as adding the word “not” prior to it, or the words “not that” or “less than” etc.), and vice-a-versa. Understanding if the “context” of a process indicates illegal activity is being performed is highly important when it comes to fraud detection. In order to reduce false alarms one must be as accurate as possible. With a ratio of 1:10,000 (one illegal activity for every 10,000 legal actions—in the financial sector) pin-pointing those transaction with no excessive noise is mandatory.

The system and method for predicting a measure of anomalousness and similarity of records in relation to a set of reference records according to a most general embodiment of the present invention, is schematically characterized by a data base comprising a set of reference records, Reference is thus made now to FIG. 1, presenting a schematic and generalized presentation of the aforementioned novel system [100] for predicting the anomalousness and similarity of input records in relation to a set of reference records. Both said input records and said reference records comprise a set of fields, from which a set of parameters can be derived. The system [100] comprises data storage [110] operative to store the set of reference records, a data receiver [120] operative to receive candidate input records [10], a data cache [130] connected to the receiver and operative to cache the candidate records, a projection analyzer running an offline process [140] connected to the data storage and operative to identify the set of parameters [20], a comparator [150] connected to both the receiver and the cache, and operative to define a candidate sequence of records [30] comprising the candidate record and zero or more records stored in the cache, a calculator [160] connected to the comparator, an output device [190] connected to said calculator and operative to output a measure of anomalousness of the candidate record (something like that, since the output is not binary but continuous.

The depicted system further comprises a projected data storage [170] connected to the computer, and calculator.

The units depicted within the dotted rectangle [180] together form an offline subsystem, while the rest of the units form an online subsystem.

The units of system [100] depicted in this figure can be implemented by one or more general purpose digital computers suitably programmed, connected together by a network, and comprising several layers of digital storage means.

One embodiment of the present invention employs two suitably programmed general purpose computers, each running the Win XP operating system and comprising an Intel CPU, solid state memory as well as hard disks. The first computer implements the offline subsystem, and the second computer implements the online subsystem.

Another embodiment of the present inventions embodies the data storage [110] using a collection of magnetic disks controlled by a controller and connected to a local network (LAN), for example Ethernet. The data receiver [120] is embodies by a general purpose computer, for example a Linux server, connected to the same LAN as well as to a wide area network, for example the internet. The data cache [130] is embodied by storage means associated with the Linux server, and comprising solid state RAM and hard disk drives. The projection analyzer [140], the comparator [150], and the comparator [160] are embodied by a grid of digital computers running a suitable program under the Windows operating system. The output device [190] according to this embodiment is connected to the calculator and comprises an ink-jet printer. Finally, the projected data storage [170] is embodied as a part of the memory connected to the grid of digital computers.

A preferred embodiment of the present invention embodies the data storage [110] using a collection of magnetic disks controlled by a controller and connected to a local network (LAN), for example Ethernet. The data receiver [120] is embodied by a general purpose computer, running for example a middleware for messaging and queuing like MSMQ or MQSeries or directly using a TCP/IP connection. The data cache [130] is embodied by storage means like TimesTen or MySQL in memory tables or a customized data table which resides on RAM. The projection analyzer [140] is embodies by a general purpose computer which can run a data warehouse environment for example Oracle DB running on Unix OS or SQL Server running on Win OS. The comparator [150], the calculator [160] and the projected data storage [170] are embodied by a blade system, for example HP ProLiant c-Class server blades or IBM eServer BladeCenter HS20 blade servers. The number of servers can be ‘d’+1, where ‘d’ is the number of dimensions in the multi dimensional space and an extra server is used as a master to control and coordinate all other blades. The output device [190] is embodied by any legacy authorization system preexisting in the organization in which the system according to the present invention is deployed.

The calculator [160] runs a program which inter alia, and according to one embodiment of the present invention calculates the number of anomalous records in a sequence of a pre-defined time window or duration, either additionally or alternatively, the program calculates the percentage of anomalous records within the sequence. The detail of such a program is obvious to those skilled in the art of computer programming.

According to one embodiment of the present invention, the calculator [160] is programmed to identify at least one field common to the candidate sequence of records, and the output device [190] is used to output this field. According to an additional embodiment of the present invention, the calculator [160] is programmed to identify a corresponding field in the reference records corresponding to this one field, and the output device is used to report whether the two fields contain the same value or parameter. This embodiment performs a finger-printing function, and usefully predicts that two values or parameters of the same field are actually describing the same entity.

The system depicted in FIG. 1 comprises projected data storage [170] to indicate that according to one embodiment of the present invention comprises this storage, and calculator [160] and projection analyzer [140] are programmed to project parameters in a multi-dimensional space and store the results in this projected data storage

Reference is now made to FIG. 2 schematically describing the operation of projection analyzer [140], an operation comprising the projection of records into multidimensional space. Record 400 is depicted as comprising inter alia of two fields. Field 420 contains a date, for example, “Wednesday”, and field 430 contains a monetary value, for example “$23.45”. These fields are passed through transformations to calculate two parameters. Field 420 is passed through transform 425 to yield the value 4, and field 430 is passed through a logarithmic transform 435 to yield that value Log(23.45). The result is a set of two parameters that are interpreted as coordinates. Coordinate system 410 is a three dimensional system, and the two parameters are used for two of its 3 coordinates. It is appreciated that other fields of record 410 are used in a similar fashion for the third coordinate and for other coordinates not depicted in this figure. Transform 425 is an example of a conversion of a discrete parameter into a real number, or more generally a vector of numbers. Such a conversion is performed, according to one embodiment of the present invention, by the following steps:
Aggregate set of parameters,
Use a cluster method to decide which and how many dimensions should be used (e.g. factor analysis),
Project the records into the multi dimensional space using the output of the cluster stage.

Reference is now made to FIG. 3 presenting a schematic and generalized presentation of the concept distance between records in a multidimensional space. Cube [600] exists in the space formed by dimensions [410] as described in reference to FIG. 2. The cube is centered on a given candidate record, which projection to this space is point [610]. Points [620], [640] and [650] are projections of three reference records. The figure depicts a situation in which these three reference records are found to be projected in the neighborhood of the candidate record. Point [650] is represented by an open circle to indicate that it is not a marked record, while the other reference records are marked, in this example. Record 630 is depicted outside the neighborhood, but it belongs to the same sequence as record 620, the sequence represented by the line connecting the two. In the situation depicted in this figure, records 610 is found to be in the neighborhood of some marked records, and therefore may be suspected to an anomalous record. However, a more accurate prediction may be found by examining the sequence to which [610] belongs.

Reference is now made to FIG. 4 presenting a schematic and generalized presentation of the concept distance between sequences records in a multidimensional space. Cube [600] described in reference to FIG. 3 is replicated in this figure for a number of records belonging to two neighboring sequences of records. Solid line [510] represents a reference sequence and dashed line [520] represents a candidate sequence. Each of the cubes including [540] and [530] represents a neighborhood in multidimensional space around a record. Cube [530] represents a reference record, and cube [540] represents a candidate record. If it happens that the reference records are marked, then there may be a basis for predicting that the candidate records are anomalous. If it happened that reference record [550], for which there is no corresponding candidate record, is marked, then there may be a basis for predicting the candidate sequence as similar to the reference sequence, followed by a prediction of the existence, perhaps in the future, of a record in the candidate sequence that would be similar to [550]. If it happens that there exists a field which value is common in the reference sequence, for example “Name=John Smith”, and there exists a corresponding field which value is common in the candidate sequence, for example “Name=Jack Brown”, then there my be a basis to identify in “Jack Brown” the finger print of “John Smith”, followed by a prediction of the existence of one entity, perhaps a person, assuming both names. The length of lines [510] and [520] depicted in this figure schematically represents the amount of time lapsing between the events recorded by the records represented by the cubes places on these lines.

Referring to FIGS. 2 and 3, the following four methods are now disclosed, methods of predicting the anomalousness of a candidate record or sequence according to the present invention.

The first method counts the number of reference records, such as [650] or [640] in the neighborhood [600] of a candidate record [610].

The second method counts the number of marked reference records, such as [620], in the neighborhood [600] of a candidate record [610].

The third method counts both numbers described above, and continues to divides one by the other to obtain the percentage of marked records.

The fourth method weights a measure of time difference with the results of the previous methods. The measure of time difference is schematically represented by the difference of length between the line [510] and line [520] segmented by the cubes such as [530] and [540], for example the difference between the length of the segments between [530] and [570] and the length of the segment between [540] and [560]. One embodiment of this fourth method compares this time difference in a candidate sequence against the typical or average time difference in reference records, for example to see if a sequence of transaction has happened too frequently or to fast.

Reference is made now to FIG. 5, presenting a schematic and generalized presentation of the aforementioned novel method [200] for predicting a measure of anomalousness and similarity of input records in relation to a set of reference records, both said input records and the reference records comprising a set of parameters, and the method comprising a preparation step [210] followed by an operation step [220], wherein the preparation step comprises a step of receiving [211] the set of reference records, and a step of identifying [212] the set of parameters, and projecting the reference records into the multi dimensional space [212], and wherein the operation step comprising a step of receiving [221] a candidate record, a step of caching [222] the candidate record, a step of selecting [223] cached records similar to the candidate record, a step of forming [224] a sequence of records comprising the candidate record, and zero or more selected cached records, a step of identifying [225] similar sequences of reference records, a step of calculating [226] a measure of anomalousness relating to the candidate record, and a step of predicting [227] the degree in which the candidate record is anomalous.

Three methods of calculating measures of anomalousness have been disclose herein in reference to FIGS. 3 and 4.

Reference is made now to FIG. 6, presenting additional steps to the method explained in reference to FIG. 5 according to an embodiment of the present invention. In this figure the step of preparation further comprises a step of quantifying [213] at least one parameter of said set of parameters of said reference records, and a step of transforming [214] at least one parameter of the set of parameters of the reference records to obtain a normalized set of parameters. This is a useful preparation to comparing reference parameters to parameters of input records. According to one embodiment of the present invention, step 213 further comprises a normalizing process in which, all dimensions are set to contribute equally to the calculating stage. Referring to the system depicted in FIG. 1, this step is mainly the operation of projection analyzer [140], while calculator [160] is employed to multiply record parameters by pre-assigned weights. The weights can be fine-tuned for optimal results.

Reference is thus made now to FIG. 7, presenting additional steps to the method explained in reference to FIG. 5 according to an embodiment of the present invention. In this figure the step of marking [227] comprises a step of generating [2271] a suspect record by marking a candidate record as suspect, and a step of marking [2272] said suspect record as anomalous. This allow for consultations with other system or with human experts, or verification of predictions against reality to take place between step 2271 and step 2272. According to one embodiment of the present invention, the step of marking comprises a step of adding the candidate record to the set of reference records, thus the reference data base of records can increase as input records are received, and become more useful as it increases.

The method disclosed herein above is useful for identifying anomalous records as well as obtaining a measure of anomalousness. A further use of the present invention for finger printing, is explained herein below in reference to FIG. 8.

Reference is thus made now to FIG. 8, presenting additional steps to the method presented in FIG. 5 according to an embodiment of the present invention capable of finger printing. Once an anomalous sequence is found, a common parameter or field can be identified. One common parameter is found of the anomalous sequence in step [310], and another parameter for the corresponding field in the reference records is found in step [320]. These two parameters can be found to be different. The field examined by these two steps is usually a description of a person, for example a person initiating a transaction. The found difference may indicate that one person has been described by two names, and the method according to this embodiment of the present invention has achieved an identification of this one person in spite of the use of two names. In other words, the method has achieved the finger printing of a person in this example, or of any entity represented by a field in general, which is reported in step [330].

The following are further details of a preferred embodiment of the present invention directed to handling business transactions such as credit card usage data. The embodiment comprises a data warehouse of which data there are performed the operations of data insert, ELT, and clustering, and a real time database on which data there is performed the operation of MDA² verification, followed by MDA² prediction. DFA (rules with prediction) is performed on the result given MQ input the result is fed to a combiner and decision making unit producing an MQ output, and performing management and users I/O. The data warehouse is the main database in which incoming transactions are stored. It stores information from all the units. On these data statistical processing, improvements and building of models is performed. Tables are built for the units described herein below, and it also serves as a backup to other units. The tables comprise a history of transactions, preferably as a text file, and in some implementations information about credit cards, such as card id., and account id numbers. A first processing step performs summations on the unmarked records. The information considered in some implementations comprises shop information (about 63 different parameters) comprising the number of customers visiting a shop per day (about 15 parameters), comprising the maximum number at the day of highest shopping activity, the average number, that can be calculated on a weakly basis and serves as an indication of the size of the shop, the variance or the standard deviation, again on a weekly basis, and an indication of the uniformity of shopping activity, and other information concerning shopping activities. The monetary value of transactions may be represented by about two parameters, comprising the average and the standard deviation of the purchases reported per shop. The frequency of shopping may be represented by about two parameters, again average and standard deviation, refereeing to the number of days between shopping activities per card. The activity in a week can be analyzed per day of the week, for example whether a shop is open for business on Sunday or Saturday, or the number of shopping activities per day relative to other days of the week. The information may be analyzed on a seasonal of monthly basis (using some 12 parameters) for example by the average daily activity per month, seasonal indication may be stored as an enumeration in which one integer value represents average activity, another integer value represents activity that is significantly higher than the average, and yet another integer value represents activity that is lower than the average. This depends on an adjustable threshold value as in is well known in the art. Another type of information relates to the type of a credit card. This can also be stored as an enumeration by integer numbers. About 5 parameters may be required to represent this information. Another enumeration may store an indication of the number of payments of each transaction. Activity may also be stored per hour in a day, for example using 24 parameters for the 24 hours of a day. An enumeration can store the relative activity per hour in a day, relative to the average in a full day.

The following formulae are known in the art for the statistical processing described herein above.

$$σ = \sqrt{\frac{1}{N} {\sum }_{i = 1}^{N} {( {x}_{i} - \overline{x} )}^{2}} \\ Or \\ = \sqrt{\frac{N {\sum }_{i = 1}^{N} {x}_{i}^{2} - {( {\sum }_{i = 1}^{N} {x}_{i} )}^{2}}{{N}^{2}}} \qquad Formula 1.1$$

Another item stored in the warehouse is the percentage of frauds among the recorded transactions. It can be represented as a real number, or as an integer number. It can be represented by an enumeration. These were examples for information that can be stored to describe a shop. The following information may be used to describe a customer, often appended to a description of a card or of an account. Calculations can be made per an account, a person, or per a card, or combination thereof. Information may be coded to represent a person's weekly activity habits, for example the frequency of shopping on a Sunday or on a Saturday. The monthly activity may be stored on a monthly basis, for example by an average value, a maximum value and a standard deviation. The type of card can be added to this information. Shopping expeditions may be represented by about 9 variables, including the average time between expeditions, determined, for example, by a gap between the time of two purchases, and its comparison with an adjustable threshold value. The number of expeditions can be used to calculate the average number of expeditions per month. Maximum, average, standard deviation etc. can be calculated for the number of shopping activities in an expedition, and the monetary values involved. The time between the first activity and the last activity overall can be used to calculate averages over this total period. The number of transactions can be analyzed on a monthly basis, as can the number of new shops visited per month. The number of shopping activities per day of a week can be stored by 7 parameters, one per a day in a week, and parameters can hold the statistics on an hourly basis.

Much information can be found in the Internet about methods of performing statistical analysis. To give one example, information about correlation can be found e.g., at http://www.uwsp.edu/psych/stat/7/correlat.htm#I1.

A second step of the method according to the present invention in this preferred embodiment comprises relating data to a set of near neighbors for building a marginal table per account or account holder or per shop. This comprises checking the contribution of each parameters (representing a dimension in a multidimensional space), and exclusion of parameters that contribute too little, i.e. the selection of meaningful dimension, factoring and data reduction. This is done per shops, clients, card holders etc. Some of the selected parameters are considered critical, or most important, by an arbitrary, rather than a statistical decision. They serve to sort the shops and clients data. All parameters are normalized, for example to a normalized standard distribution. A table is generated to contain the average and standard deviation per each dimension of the multidimensional space. The following formula may be used for a vector of data ‘X’ per each dimension, per each client, shop, account, etc.

These details of implementation add to the disclosure herein above in reference to FIG. 2.

X′=(X−Average(X))/StandardDeviation(X); Formula 1.2

Data can now be divided into groups by the chosen critical dimensions. For example, 3 critical parameters form a division into 27 groups. Finding the nearest neighbors is done on the basis of a selection of the optimal number for records per dimensions, a number that can be stored in a table of adjustable parameters of the method. This step is concluded by finding the nearest neighbors and updating the database. In a typical implementation there is a total of about 79 parameters describing a shop and 45 parameters describing an account, client or card.

Dealing with neighboring records in a multidimensional space as described herein above in reference to FIG. 3 in this preferred embodiment involves MDA². The code presented in the following formulae serves as an example.

Formula 1.3:
Select Count *
from
Where
   {Min, Max Server Blade No' 1
& {In, . . . , } Server Blade No' 2
& {,} Server Blade No' 3
& {,} Server Blade No' N

Formula 1.4:
Select Count *
from
Where
   {,} Server Blade No' 1
& {,} Server Blade No' 2
& {,} Server Blade No' 3
& {,} Server Blade No' N
& Where Event {A}
   {,} Server Blade No' 1
   {,} Server Blade No' 2
   {,} Server Blade No' 3 ,
   {,} Server Blade No' N
&Where TimeDiff(Event(A), Event(B))<24h

These formulae relate to a preferred embodiment of a system according to the present invention comprising Blade servers as describe herein above in reference to FIG. 1. In this embodiment one Blade server is assigned to each one dimension of a multidimensional space. In this embodiment 1 rack comprises 96×3.4 GHz Xeon CPUs, 384 GBytes Memory, 13.8TB Local Raw Disk or External SAN to form a single database platform.

Disclosure now continues with details of a proffered embodiment of a method according to the present invention. The following step deals with accepting a candidate record, and comprises the following five sub-steps. The first sub-step comprises obtaining a record from a sequential file, a queue or the like. The real time database is assigned this information. Many databases are known in the art to perform such an operation, or example using the STL format. There can be a further sub-step of pre-preparation, for example in numbering the records. For example, given three records groups that may form sequence, ‘A’, ‘B’ and ‘C’, there can be a step of deciding after the acceptance of ‘A’, whether to continue forming a sequence with ‘B’, and then deal with ‘C’. This can be done on the basis of the number of transactions represented by ‘A’, ‘B’ and ‘C’

A second sub-step may convert the received data to internal representation. For example data may be compressed or long card id. numbers represented by shorter number to save memory and processing time. Record fields such as those representing dates and times may need to be reformatted to the internal format used by the system according to the present invention. The third sub-step first deals with a record ‘A’, as is represented by the following formula.

Formula 1.5:
Select Count(*),sum (Fraud)
   From Tran Where
      1 Select (customer→100,000 Tran Where
         card_id=Card_New_Id)
      2 Select (Shop→100,000 shop Where Shopf=Shop_I)
      3 Select (min,max,amount)
      4 Select (min,max Time)

Then, similar processing is performed on ‘B’, ‘C’ and any further records. Problems may arise at this stage because of the existence of the following possibilities: ‘B’ follows ‘A’, ‘B’ precedes ‘A’ but at time difference higher than a predetermined threshold, and there is much of ‘B’. One solution according to the present invention is to examine a window in time domain of a predetermined width. Another solution involves joining a table of ‘A’ with a table of ‘B’ and count the number of joint items the answer a predetermined condition or the number of marked records in the joint table, a date and time field is then added to the joint table, and serves to compare ‘A’ with ‘B’. (‘A' is current, ‘B’ was done before ‘A’, and ‘C’ before ‘B’). To clarify, this discussion involved the lack of synchronization between the time of reception of records into the system, and the time of actual transactions represented by these records. At the end of this sub-step ‘A’, ‘B’ and ‘C’ need to be updates and incremented. The fourth sub-step involves the management of changes in lag information. This lag is incremented by one after each transaction. At the end of each day, the lag can be transferred to the data base, and trimmed by about a half. The fifth sub-step involves forwarding the information to a combiner for the calculating of probabilities. Such information may comprise the functions described by the following formulae, continuing with the example of A, B and C.

Information=Count(A), Sum(A), Count(BA), Sum(BA), Count(CBA), Sum(CBA) Formula 1.6:

The next step is sub-divided into two sub-steps. The first forms a file of all ‘A’ records found in the previous step, a file including card id., and date and time differences, as well as the margins to identify the ‘A’. The second forms a flat file of all ‘A’ transactions by joining. The file is filtered to contained transactions of a predetermined time window, typically 5 hours. The transactions are forwarded to the next step.

The next step is sub-divided into four sub-steps. The first sorts the transactions in the file by card id. and time, finds a minimum of the times, averages the minimum over card id., and a standard deviation. The second joins transactions to pairs, and performs the same actions as the first on the pairs. The thirds repeats the same for sets of three. The results are forwarded to the next sub-step, as well as the margin calculated by the following formula.

[min]<Average(X)−2 StandardDeviation(X)<max Formula 1.7:

The fourth sub-step accepts the file of transactions and forms a matrix of distances is parameters such as space, money value and time. The number of records in a neighborhood is examined, and the size of a neighborhood is changed to arrive at a meaningful and convenient number. Statistics are calculated for the records in the neighborhood. The last step involves output and decision making according to the specific application and use of the present invention.

1. A method for predicting a measure of anomalousness of candidate record sequences of transactions (CRS) by use of a set of reference record sequences (RRS), each of said RRS being characterized by a measure of anomalousness A_{R}, said method comprising steps of:
a. storing said RRS in data storage means, and receiving said CRS in real time by use of data storage and transmission means;
b. projecting said RRS and CRS into a multi-dimensional space;
c. computing a distance d from each said RRS to said CRS in said multidimensional space;
d. selecting the subset of RRS falling within a predetermined distance d of said CRS;
e. computing a measure A_{C} of anomalousness of said CRS based on the measure A_{R} of the anomalousness of said subset of RRS;
f. outputting said measure of anomalousness A_{C} by means of an output device;
whereby sequences of candidate records are compared to sequences of reference records to arrive at measures of anomalousness of said candidate records.

2. The method of claim 1 where said measure A_{C} is a function ƒ of said A_{R} and said distance d.

3. The method of claim 2 where said function ƒ is a monotonically decreasing function of said distance d and a monotonically increasing function of said A_{R}.

4. The method of claim 1 where said measures of anomalousness are selected from the group consisting of: Boolean numbers, real numbers, vectors.

5. The method of claim 1 wherein said distance d is computed by means of a distance function selected from a group consisting of: a monotonic function of said candidate records' Euclidean distances from said reference records; a threshold function of said candidate records' Euclidean distances from said reference records; a function of non-Euclidean distance between said candidate records and said reference records.

6. The method of claim 1 further adapted to repeat said computation of anomalousness for a group PCRS of CRS and further computing a group anomalousness selected from the set consisting of: the weighted anomalousness of said PCRS; the maximum anomalousness of said PCRS.

7. The method of claim 1 further providing a measure of prediction strength based on the size of said subset of RRS falling within said predetermined distance d of said CRS.

8. The method of claim 7 further varying said distance d to control said prediction strength.

9. The method of claim 1 adapted for allowing or denying transactions based on said measure of anomalousness A_{C}.

10. A system for predicting a measure of anomalousness of candidate record sequences (CRS) including current and previous transactions of a given entity, in relation to a set of reference record sequences (RRS), each of said RRS being characterized b a measure of anomalousness A_{R}, said system comprising:
a. data storage and receipt means adapted to store said RRS and to receive said CRS in real time;
b. projection analyzer connected to said data storage means adapted to project said RRS and CRS into a multi-dimensional space;
c. distance computing means adapted to compute a distance d from said RRS to said CRS in said multidimensional space;
d. selection means adapted to select the subset of RRS falling within a predetermined distance d of said CRS;
e. anomaly computing means adapted to compute a measure A_{C} of anomalousness of said CRS based on the measure A_{R} of the anomalousness of said subset of RRS;
f. an output device connected to said anomaly computing means and operative to output said measure of anomalousness A_{C};
wherein sequences of candidate records are compared to sequences of reference records to arrive at a measure of anomalousness of said candidate records.

11. The system of claim 10 where said measure A_{C} is a function ƒ of said A_{R} and said distance d.

12. The system of claim 11 where said function ƒ is a monotonically decreasing function of said distance d and a monotonically increasing function of said A_{R}.

13. The system of claim 1 where said measures of anomalousness are selected from the group consisting of: Boolean numbers, real numbers, vectors.

14. The system of claim 10 wherein said distance d is computed by means of a distance function selected from a group consisting of: a monotonic function of said candidate records' Euclidean distances from said reference records; a threshold function of said candidate records' Euclidean distances from said reference records; a function of non-Euclidean distance between said candidate records and said reference records.

15. The system of claim 10 further provided with computing means adapted to repeat said computation of anomalousness for a group PCRS of CRS including said current transaction and some subset of previous transactions, further provided with group anomalousness computation means adapted to compute a group anomalousness selected from the group consisting of: the weighted anomalousness of said PCRS; the maximum anomalousness of said PCRS.

16. The system of claim 10 further adapted to provide a measure of prediction strength based on the number of said RRS falling within said predetermined distance d of said CRS.

17. The system of claim 16 further adapted to vary said distance d to control said prediction strength.

18. The system of claim 10 adapted for allowing or denying transactions based on said measure of anomalousness A_{C}.
